(19) United States
(12) Patent Application Publication
(10) Pub. No.: US 2006/0160500 A1
(43) Pub. Date: Jul. 20, 2006

(54) VSAT block up converter (BUC) chip

(75) Inventor: Danny F. Ammar, Windermere, FL (US)

Correspondence Address: RICHARD K. WARTHER;ALLEN, DYER,DOPPELT,MILBRATH & GILCHRIST P.A., 1401 CITRUS CENTER 255 SOUTH ORANGE AVENUE, P.O. BOX 3791, ORLANDO, FL, 32802-3791, US

(73) Assignee: XYTRANS, INC., Orlando, FL (US)

(21) Appl. No.: 11/036,908

(22) Filed: Jan. 14, 2005

(51) Int. Cl. H04B 1/04; H01Q 11/12; H04B 1/10

(52) U.S. Cl. 455/118

(57) ABSTRACT

A Block Up Converter (BUC) chip includes a base board with opposing top and bottom metal layers and having radio frequency (RF) circuits at the top metal layer and ground and signal pads at the bottom metal layer. Microwave Monolithic Integrated Circuit (MMIC) chips are carried by the base board and operative with the RF circuits and ground and signal pads for receiving and up converting signals. A top cover protects the MMIC chips.

### FIELD OF THE INVENTION

The present invention relates to the field of communications, and more particularly, this invention relates to the field of Block Up Converters (BUC's), for example, used in Very Small Aperture Terminal (VSAT) communications systems.

### BACKGROUND OF THE INVENTION

In the early days of satellite communications, there were few downlink earth stations. Those few stations in existence were essentially large antenna dishes operative with wired communications hubs. Any communications signals received at these large earth stations were distributed through wires and cables to numerous destinations, including other communications hubs. As a result, many earth stations were positioned in metropolitan areas and acted as communications hubs, which distributed communication signals in broadcast fashion to other communications hubs, regional communications centers, or local home and residence sites via cable. It was not convenient to have a large number of smaller, earth station terminals using this prior art wired technology as described.

This scenario changed with the advent of Very Small Aperture Terminal (VSAT) communications systems and networks. VSAT systems are cost-effective communications networks that allow many smaller VSAT terminals to be geographically dispersed and located in many different areas, including rural and metropolitan areas. VSAT networks support internet, voice/fax, data, LAN and many other communications formats, broadening the range of communications services and lowering the overall system, network and communications costs to previous prior art systems using wired technology.

A VSAT network usually includes a large central earth station, known as a central hub (or master earth station), a satellite transponder, and a large number of geographically disbursed, remote VSATs. The satellites are typically positioned in a geostationary orbit about 36,000 kilometers above the earth. A VSAT terminal receives and transmits signals via the satellite to other VSAT's in the network. The term “very small” used in the name VSAT refers to the small antenna dish commonly seen in various locales typically about three (3) to about six (6) feet in diameter and mounted in an accessible but adequate location for communications, such as a roof, building wall, or on the ground. A VSAT terminal has an outdoor unit (ODU), which includes an antenna, low noise blocker (LSB) in some instances, and a VSAT transceiver as part of the outdoor electronics and other components. The antenna usually includes an antenna reflector, feed horn and an antenna mount or frame. The outdoor electronics constitute part of the outdoor unit and usually include low noise amplifiers (LNA) and other transceiver components, for example, a millimeter wave (MMW) transceiver. Many of these VSAT terminals include converter circuits, for example, a Block Up Converter (BUC), which converts L-band signals to Ka-band signals, for example. In a BUC, an incoming IF signal could be mixed with a local oscillator (LO) signal, filtered, and amplified to produce a Ka-band signal to an antenna.

The indoor unit (IDU) is typically operative as a communications interface. It could be formed from various functional components, for example, a desktop box or PC, and contains the electronics for interfacing and communicating with existing in-house equipment, such as local area networks, servers, PC's and other equipment. The indoor unit is usually connected to the outdoor unit with a pair of cables, e.g., usually a coaxial cable. Indoor units also include basic demodulators and modulators for operation.

In the next few years a number of Ka-band (27.5 to 30 GHz) satellites will be launched that will enable remote Internet access via two-way communications with user terminals. To compete successfully with other internet services, such as Digital Subscriber Line (DSL) and cable modem, the cost of these Very Small Aperture Terminals (VSAT's) must be further reduced. As noted before, each Very Small Aperture Terminal typically includes an antenna, a diplexer, and a millimeter wave (MMW) transceiver. To compete successfully with these other internet service providers, the costs of these ground terminals must be driven to very low levels.

In many current VSAT designs, the millimeter wave (MMW) transceiver circuit accounts for almost 75% of the total cost of the VSAT terminal. Unlike most lower frequency Ku-band transceivers, which can be built from low cost discrete components using low cost soft board, for example, Rogers board, a Ka-band transceiver requires tighter tolerances because of its inherent shorter wavelength in the millimeter wave range. One current method used by many manufacturers for manufacturing these transceivers is to pre-package the Ka-band MMIC chips in surface mount packages using traditional surface mount technology (SMT) assembly methods. Although this method is widely used throughout the industry, it has not been a successful approach for driving down the costs of VSAT's because the packaging of MMIC's and their required tuning after assembly has been expensive.

In addition to this cost issue, as the number of VSAT terminals increases to perhaps millions of units in the next few years, the amount of power transmitted from a ground unit operative as a VSAT terminal to any satellite transponders will have to be better controlled not only for cost considerations, but also because of the larger number of terminals in one area. For example, most VSAT terminals require low power to operate in clear weather, while higher power is required to overcome adverse weather conditions and maintain a high rate of service availability. The well-known practice of continuously “blasting,” i.e., transmitting high power signals, would reduce transceiver reliability, as maximum heat is constantly generated, shortening component life.

### SUMMARY OF THE INVENTION

It is therefore an object of the present invention to provide a Very Small Aperture Terminal (VSAT) transceiver that overcomes the disadvantages of packaging millimeter wave (MMW) Monolithic Microwave Integrated Circuit (MMIC) chips in surface mount packages using traditional surface mount technology assembly methods.

It is yet another object of the present invention to provide an efficient Block Up Converter (BUC) chip for use in VSAT and similar applications.

In accordance with the present invention, a Block Up Converter chip is integrated into a single surface mount technology chip, resulting in substantial costs and space savings.

In accordance with the present invention, the Block Up Converter chip includes a base board formed from a dielectric material and opposing top and bottom metal layers. These form a respective top ground and bottom RF ground. The top metal layer has radio frequency (RF) circuits and the bottom metal layer has ground and signal pads. Microwave Monolithic Integrated Circuit (MMIC) chips are carried by the base board and operative with the RF circuits and ground signal pads for receiving and up converting signals. A top cover is positioned over the base board for protecting the MMIC chips.

In one aspect of the present invention, the MMIC chips include a sub-harmonic mixer MMIC chip that receives and mixes together an intermediate frequency (IF) signal and local oscillator (LO) signal and up converts the IF signal into a higher frequency RF signal. The MMIC chips can also include a driver amplifier MMIC and high power amplifier (HPA) MMIC operatively connected to the sub-harmonic mixer MMIC chip for amplifying the RF signal.

In yet another aspect of the present invention, the top cover includes an inside surface over the MMIC chips and has channelization providing isolation between RF circuits and MMIC chips. A metallized layer can be formed on the inside surface of the top cover and form a waveguide channel. Vias can extend through the base board and connect the top and bottom RF grounds. Other vias can extend from a top metal layer to bottom signal pads for carrying input and output signals. A bottom metal layer can be configured for surface mounting on an RF board or flanges can be included for mounting the base board, wherein the flanges include signal terminals operative with the MMIC chips and RF circuits.

In yet another aspect of the present invention, surface mounted by-pass capacitors can be mounted on the base board with wire bonds interconnecting by-pass capacitors and MMIC chips to RF circuits. Cut-outs can be formed within the base board which receive respective MMIC chips. A conductive epoxy can be used for securing the MMIC chips within the cut-out to a bottom metal layer.

In yet another aspect of the present invention, filters are formed on the base board and operative with the RF ciruits and HPA MMIC, driver amplifier MMIC, and sub-harmonic mixer MMIC. A surface mounted IF amplifier is operatively connected to the sub-harmonic mixer MMIC for amplifying the IF signal into the sub-harmonic mixer MMIC.

### BRIEF DESCRIPTION OF THE DRAWINGS

Other objects, features and advantages of the present invention will become apparent from the detailed description of the invention which follows, when considered in light of the accompanying drawings in which:

FIG. 1 is a block diagram of an example of a prior art KA-band Very Small Aperture Terminal (VSAT) Block Up Converter (BUC) circuit positioned on an RF board.

FIG. 2 is a fragmentary, block diagram of a prior art Ka-band VSAT BUC circuit component layout functionally similar to the circuit in FIG. 1 and showing an example of the placement of components on an RF board contained in a housing.

FIG. 3 is a block diagram showing basic functional circuit components of a Block Up Converter (BUC) chip in accordance with the present invention.

FIG. 4 is a fragmentary block diagram showing the layout of functional circuit components on an RF board for the Block Up Converter chip of the present invention and similar to the example shown in FIG. 3.

FIG. 5 is a fragmentary, top plan view of an example of the chip cover used in the Block Up Converter chip in accordance with the present invention.

FIG. 6 is a fragmentary, bottom plan view of an example of the underside or bottom metal layer forming the Block Up Converter chip of the present invention.

FIG. 7 is a partial, cross-sectional view of the Block Up Converter chip in accordance with the present invention.

FIGS. 8A-8C show respective top, side elevation and bottom views of the Block Up Converter chip of the present invention, such chip being adapted for surface mount technology.

FIG. 8D is a plan view of an example of the BUC chip of the present invention in accordance with a second embodiment and showing a flange configuration that allows board mounting of the chip using the flanges.

FIG. 9 is a fragmentary, sectional view of the Block Up Converter chip positioned on an RF board and using thermal vias formed in the RF board for heat transfer.

### DETAILED DESCRIPTION OF THE PREFERRED EMBODIMENTS

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout, and prime notation is used to indicate similar elements in alternative embodiments.

One prior art method of building Ka-band and similar wavelength Block Up Converters (BUC's) is to prepackage MMIC chips in surface mount packages, which in turn, are secured to a board using traditional SMT assembly methods to produce the final BUC product. Although this method is widely used by many manufacturers, it has not been successful for driving down the manufacturing costs because the packaging of the MMIC's and their final tuning required after assembly processes, which proved expensive.

The present invention solves these prior art problems and is directed to a low cost, preferably Ka-band Very Small Aperture Terminal (VSAT) Block Up Converter (BUC) formed as a single Surface Mount Technology (SMT) chip. The present invention provides a low cost, miniature VSAT BUC that integrates all functions on a single chip, allowing about a 10:1 reduction in size as compared to prior art Block Up Converters that were similar in function. The VSAT BUC chip of the present invention uses a low cost soft board as a base carrier for the MMIC's and filter synthesis. A chip cover can be made from low cost plastic or other similar material and is used to protect the bare MMIC chips or die and other components. The base formed from an RF board and the chip cover when assembled form a Surface Mount Technology (SMT) chip that mounts directly to a main board, for example, a larger and much thicker Radio Frequency (RF) board. This miniature SMT BUC chip simplifies manufacturing by incorporating all millimeter wave (MMW) functions into a single BUC chip. The VSAT BUC chip of the present invention also improves efficiency by reducing losses that result in reduced power dissipation.

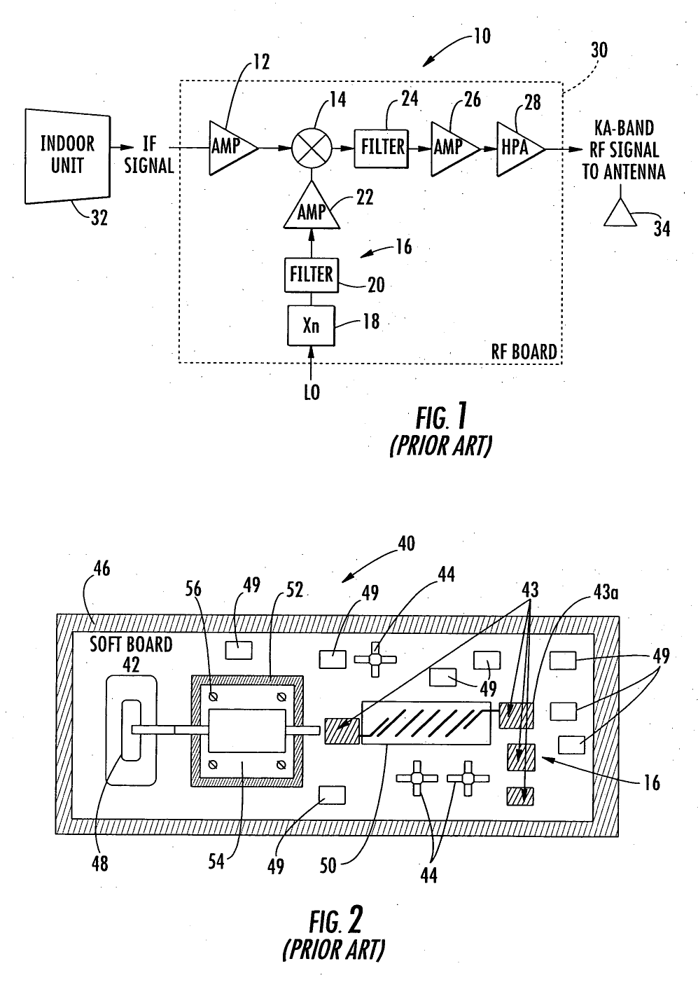

FIG. 1 is a block diagram of an example of a prior art Ka-band VSAT BUC 10. This prior art example includes an IF amplifier 12 that receives an IF signal, a mixer 14, that receives the IF signal from the amplifier 12 and a local oscillator (LO) multiplier circuit chain 16 that receives a local oscillator (LO) signal. The circuit chain 16 includes a local oscillator (LO) multiplier 18, a LO filter 20, and LO amplifier 22, which passes signals to the mixer 14. The mixed signal from the mixer 14 is at Ka-band and is filtered in a main filter 24. The signal is amplified by a driver amplifier 26 and a final stage high power amplifier (HPA) 28. These components are typically mounted on an RF board 30. In this circuit, the input intermediate frequency (IF) signal from an indoor unit 32, typically at L-band, is amplified by the IF amplifier 12, up-converted to Ka-band in the mixer 14, filtered, amplified and sent to the antenna 34.

FIG. 2 shows an example of a prior art Ka-band VSAT transmitter 40 layout on a soft board 42 having some circuits functionally similar to the prior art Ka-band VSAT BUC 10 shown in FIG. 1. This transmitter 40 uses packaged MMIC chips 43 and discrete devices 44 on the soft board 42 for radio frequency (RF) circuits. As illustrated, the soft board 42 is contained in a housing 46 and includes a waveguide transition 48. The various surface mount technology packaged MMIC chips 43 are illustrated with other surface mount technology electronic circuit components 49. An etched filter 50 is formed on the soft board 42. The soft board 42 has a cut-out 52 that receives a high power amplifier (HPA) 54 or another similar amplifier circuit component that is mounted and secured with mounting screws 56. The packaged MMIC chips or die 43, typically five or six, correspond to many functional components shown in FIG. 1, and are either surface mounted to the top of the RF soft board 42 or are attached directly to the housing 46 using screws. The soft board 42, typically made of Rogers material, is cut to form cut-outs and allow direct attachment of the High Power Amplifier (HPA) 54 as illustrated. The filters 50 are typically etched on the top surface of the soft board 42 using manufacturing techniques known to those skilled in the art. The configuration in FIG. 2 shows the mixer MMIC 43a connected to various MMIC chips forming the local oscillator circuit chain 16.

FIG. 3 is a block diagram of an example of the BUC chip 100 of the present invention. As illustrated, the BUC chip 100 receives an IF signal from an indoor unit 102, which sends the signal into the IF amplifier 104 as a first component of the BUC chip 100. After amplification, this IF signal is mixed with a local oscillator (LO) signal in a sub-harmonic mixer 106, which includes an amplifier circuit 108, multiplier circuit 110, and mixer circuit 112. After mixing, the mixed signal at a preferred Ka-band in this non-limiting example, is filtered within filter 114, amplified at amplifier 116, filtered again at filter 118, and amplified by high power amplifier 120. This highly amplified signal is then filtered in a last stage filter 122 and passes as a preferred Ka-band RF signal to the antenna 124. The components in this BUC chip 100 of the present invention are mounted on an RF board 126 shown by the dashed lines. The intermediate frequency (IF) signal is received in the intermediate frequency (IF) amplifier 104, where it is transferred to the sub-harmonic mixer circuit 106 that includes the amplifier circuit 108, multiplier circuit 110 and mixer circuit 112. From the sub-harmonic mixer circuit 112, the signal passes to the first filter circuit 114, followed by a driver amplifier circuit 116 and a second filter circuit 118. After filtering, the signal passes into the high power amplifier (HPA) 120 and through another filter circuit 122 and out as an RF signal to the antenna 124.

This BUC chip 100 includes all the functions of a typical BUC circuit of the prior art, such as described relative to FIGS. 1 and 2, but has fewer millimeter wave (MMW) Microwave Monolithic Integrated Circuits (MMIC). The number of MMW MMIC's has been reduced from five in the current art, such as shown in FIGS. 1 and 2, to just three in this non-limiting example of the present invention. These three MMIC chips include the high power amplifier 120, sub-harmonic mixer 106, and driver amplifier 116. The lower MMIC count results in lower cost and higher efficiency. The IF amplifier 104 is preferably a low cost SMT part that can be purchased from many sources such as Sirenza, Agilent or RFMD. The sub-harmonic mixer MMIC chip 106 provides the IF signal up-conversion to Ka-band and amplifies the LO signal and multiplies it by two in the multiplexer section 110. The amplifier driver MMIC 116 and the HPA amplifier MMIC 120 can be high efficiency low cost MMIC chips that can be purchased from multiple sources such as Triquint, Velocium or UMS. The filters 114, 118 and 122 can be etched on the baseboard 126 formed by the RF board.

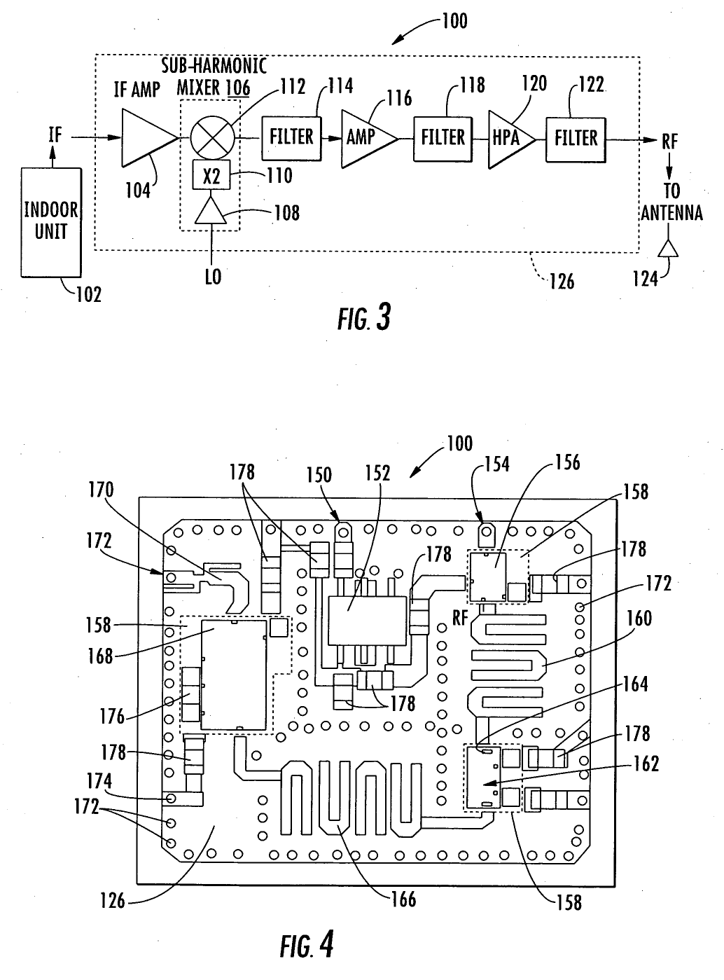

FIG. 4 shows the layout of various functional components, devices and MMIC chips of the BUC chip 100. FIG. 5 is a top plan view of its cover 130. In FIG. 4, the RF board 126 is shown with various MMIC chips, electronic devices, capacitors and input/output terminals. A description starting at the various inputs will now follow.

The RF board 126 typically will have various circuits that are etched or formed with stripline and microstrip circuits, as illustrated. The IF input 150 is connected to a surface mounted IF amplifier 152, which is connected to a sub-harmonic mixer MMIC 156. This sub-harmonic mixer MMIC 156 receives a local oscillator input signal at a local oscillator input 154 connected to a high frequency generator circuit or other circuit for producing a local oscillator signal. The sub-harmonic mixer MMIC 156 is received within a board cut-out 158. The signal is passed into a printed filter 160 and to a driver amplifier MMIC 162, which is connected to various circuits using various wire bonds 164. This driver amplifier MMIC 162 is also received in a cut-out 158. The signal from the driver amplifier MMIC 162 is passed into another printed filter 166 and into a high power amplifier (HPA) MMIC chip 168 and output through the printed filter 170 to an RF output terminal 172. Other components include ground vias 172, signal vias 174, by-pass capacitors 176, and various surface mount capacitors 178, as illustrated. The sub-harmonic mixer MMIC 156, driver amplifier MMIC 162, and HPA MMIC 168 are contained in various board cut-outs 158 as illustrated.

The filters 160, 166, 170 can be formed in a manner similar to that disclosed in commonly assigned U.S. Pat. No. 6,483,404, the disclosure which is hereby incorporated by reference in its entirety. Other etching or printing techniques for forming the filters could also be used. The RF board 126 forming the base of this BUC chip 100 can be formed from a glass microfiber reinforced PTFE composite, such as manufactured by Rogers Corporation, under the designation RT/Duroid® 5870/5880, high frequency laminate. This type of board can be designed for exacting stripline and microstrip circuits. It has low electrical loss, low moisture absorption, chemical resistance, and uniform electrical properties over different frequencies. It is also isotropic. This type of board can be cut easily and is usually supplied as a laminate with an electrode deposited metal layer on top and bottom. The thickness of the metal layers can vary, but typically it is as little as one-fourth to as much as two ounces per square foot (8-70 micrometer) on both top and bottom. The top and bottom metal layers could be formed and clad with rolled copper foil. The cladding could also be formed from different types of metals, including aluminum, copper or brass plate. The board usually includes a dielectric located between the metal plate layers. The boards can have a standard thickness with as little as 0.005 inches (0.127 mm). Of course, the boards come in very large sizes of about 0.125 inches thick, but this type of thickness would not be anticipated for use in the present invention except in rare circumstances.

The high temperature, surface mount capacitors 178 can be operative to temperatures up to about 200° C. or more with rated working voltages varying depending on the end use. These capacitors can handle high power voltage levels in many different RF applications. In one example of the present invention, 0402 capacitors can be used. In some designs, better, improved 0403 capacitors could be used. Both, however, provide high “Q” chip geometries and can be formed as lower cost P-NPO ceramic capacitors. They have high solderability and a varying temperature coefficient with high insulation resistance, dielectric strength and capacitance.

The RF board 126 has a number of ground vias 172 to provide any required isolation. Signal vias 174 can be used to interconnect various components. By-pass capacitors 176 can have appropriate connections for signal vias 174. The high power amplifier MMIC 168 is connected by the printed filter 170 to the RF output terminal 172. Another printed filter 166 interconnects the HPA MMIC 168 and the driver amplifier MMIC 162, which includes various wire bonds 164 for circuit connection, and a printed filter 160 interconnecting the driver amplifier MMIC 162 and the sub-harmonic mixer MMIC 156. The local oscillator input 154 connects to the sub-harmonic mixer MMIC 156. The surface mounted technology intermediate frequency (IF) amplifier 152 is connected to the IF input 150 and various Surface Mount Technology (SMT) capacitors 178.

The cover 130 shown in FIG. 5 preferably includes channelization 130a and cover walls 130b. The cover 130 can be made from plastic or other material and extends across the top surface of an RF board 126 shown in FIG. 4. The cover 130 is dimensioned to fit over the board 126 shown by the similar outline configuration of FIGS. 4 and 5. The channelization 130a could be formed similar to the channelization as disclosed in commonly assigned U.S. Pat. No. 6,788,171, the disclosure which is hereby incorporated by reference in its entirety.

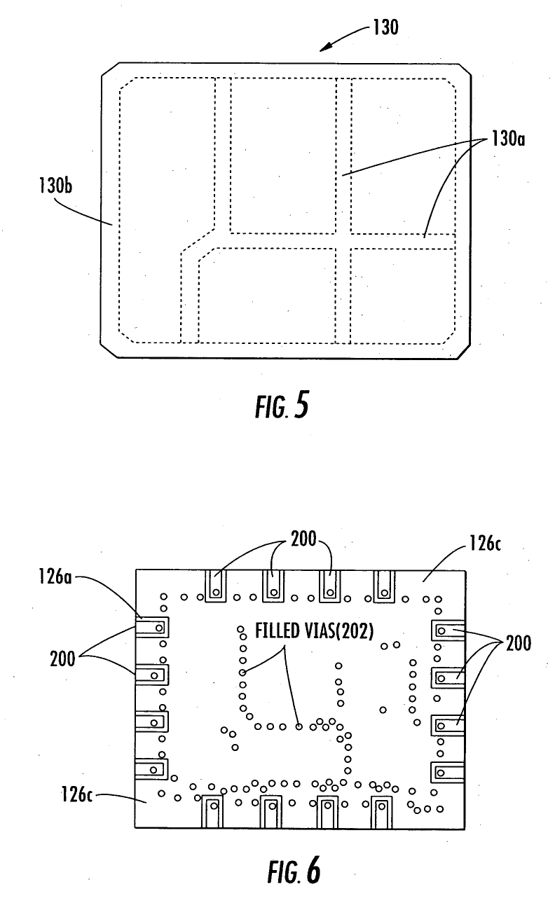

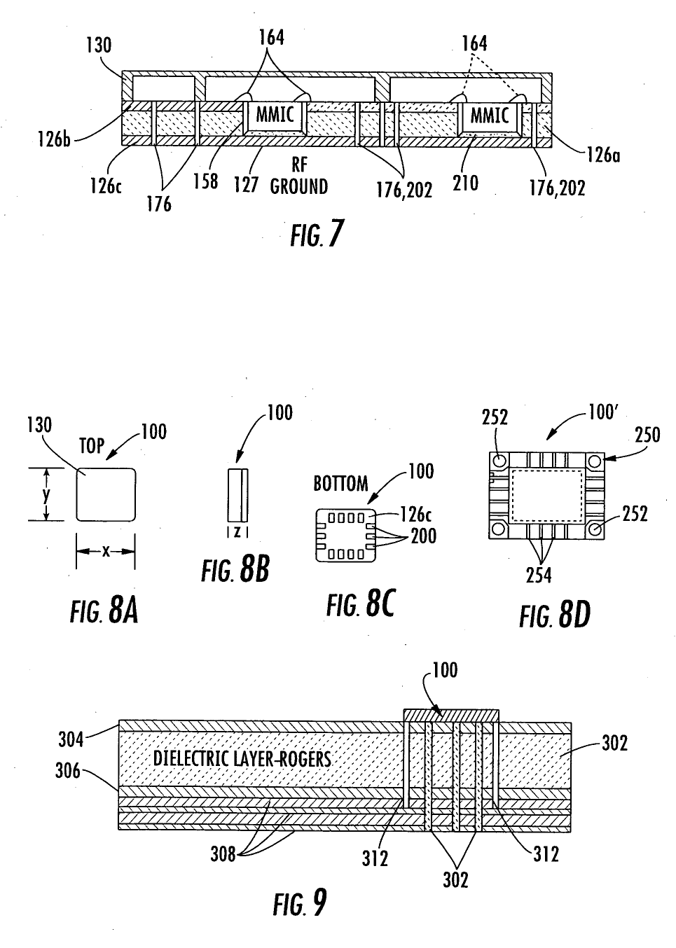

The composite BUC chip 100 measures approximately 15 mm×14 mm×2 mm in one non-limiting example, as shown by the x, y and z dimensions in FIGS. 8A and 8B. The base formed from the RF board 126 of BUC chip 100 is preferably made from Rogers material, such as the 5880 type board as described before. This material comes in large sheets, with various copper or other metal layer thicknesses positioned on the top and bottom of a dielectric material 126a. The two metal layers form a top metal layer 126b and bottom metal layer 126c as shown in FIG. 7.

For this non-limiting application, a one to two ounce copper layer forming the respective top and bottom metal layers 126b, 126c has been found adequate. The top metal layer 126b is used for creating a top ground and etched RF circuits, such as 50 ohm lines and filters. The bottom metal layer 126c is used as a base for the chip and can be etched to create any signal and ground pads (FIG. 6). FIG. 6 shows the bottom metal layer 126c with exposed dielectric material 126a forming different chip input/output leads 200 and filled vias 202 corresponding to different vias shown in FIG. 4. This chip base is processed by normal soft board fabrication methods. The copper layer can be gold plated. Any filters are etched and the vias are drilled and filled. The top metal layer 126b and any dielectric layers 126a are removed in places where the MMIC chips and the by-pass capacitors 176 are installed as best shown in FIG. 6. The RF board at this time forms a chip carrier and is processed, using SMT methods including solder deposition, to install all the SMT components and devices, mainly the IF amplifier 152 and the 0402 size SMT capacitors 178. The MMIC's are next installed in their formed cavities. This is accomplished by using silver epoxy with a lower cure temperature, for example, Diemat 6030 epoxy that cures at 150° C., rather than using solder, which is used in this non-limiting example to attach SMT components and devices.

After the MMIC chips are assembled and the epoxy is cured, automatic wire bonding can be used to connect the MMIC chips and any associated by-pass capacitors 176 to other circuits. The channelized cover 130 is installed, which is preferably made from low cost dielectric material or plastic. It is placed over the base carrier using epoxy or solder. Some area of the cover may require metallization to improve isolation between different circuits and provide a waveguide channel for the filters.

FIG. 6 shows the bottom of the BUC chip 100 of the present invention, and more particularly, the bottom metal layer. As illustrated, the bottom of the chip includes the filled vias 202 and chip input/output leads 200 surrounded by the exposed dielectric material 126a. The bottom metal layer 126c is preferably formed from a gold plated copper, which is the same copper layer and attached and manufactured to the Rogers material forming the RF board. The bottom metal layer 126c has been etched to create the input and output ports 200 of the BUC chip 100. These parts 200 and planar configuration allow this BUC chip 100 to be mounted to another board, for example, an RF board using normal SMT processes. Input and output signals are carried from the top layer to the bottom leads using the filled vias 202. Also, a large number of vias are used to connect the top ground to the bottom RF ground formed by the metal layers.

FIG. 7 shows a cross section of the BUC chip 100 of the present invention, showing further details on the assembly of the chip. As illustrated, the MMIC chips 156, 162, 168 can be secured by the epoxy 210 with various wire bonds 164 to the metal layers 126b, 126c as shown. The vias 176, 202 are shown extending between the metal layers, and the dielectric layer 126a is shown therebetween. The bottom metal layer 126c forms the RF ground 127. The board cut-outs 158 in the dielectric layer 126a receive the MMIC chips 156, 162, 168. The cover 130 is shown attached over the RF board forming the BUC chip 100 of the present invention.

FIGS. 8A through 8D show the approximate dimensions of two embodiments of the BUC chip. FIGS. 8A through 8C show a surface mount technology (SMT) BUC chip 100, similar to what is described relative to FIG. 7. FIG. 8D shows flanges 250 around the outer edge of this BUC chip 100′. Common elements in this second embodiment are given the prime notation. The flange 250 includes mounting holes 252 and terminals 254, which connect to different signal lines, components and terminals of the BUC chip of the type as described before. The BUC chip 100 in the surface mount technology version shown in FIGS. 8A through 8C is about 14 mm by about 15 mm by about 2 mm, in this non-limiting example, and is shown in FIG. 8A with the top plan view, the side elevation view in FIG. 8B, and the bottom view in FIG. 8C. The flange mount version of the BUC chip 100′ is shown in FIG. 8D. The SMT version 100 is mainly used for low power (up to 5 watts). The flange version 100′ is for higher power (up to 20 watts). Just as in the case of any SMT part that generates heat, this BUC chip 100 can be soldered directly on top of an RF board with many thermal vias underneath it for thermal heat transfer.

As shown in FIG. 9, the BUC chip 100 is secured to another larger RF board 300 to form part of a VSAT system in this non-limiting example. This board 300 can be formed from Rogers material and can include a dielectric layer 302 and includes on either side metal layers 304, 306 with a number of other signal and ground layers 308. Thermal vias 310 and signal vias 312 connect to the BUC chip as illustrated. Of course, many different types of RF boards can be used, including that disclosed in commonly assigned U.S. Pat. No. 6,759,743, the disclosure which is hereby incorporated by reference in its entirety.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims.

That which is claimed is:

1. A Block Up Converter chip comprising:
a base board formed from a dielectric material and opposing top and bottom metal layers forming a respective top and bottom RF ground, said top metal layer having Radio Frequency (RF) circuits and said bottom metal layer having ground and signal pads;
microwave monolithic integrated circuit (MMIC) chips carried by the base board and operative with said RF circuits and ground and signal pads for receiving and up converting signals; and
a top cover positioned over said base board for protecting said MMIC chips.

2. A Block Up Converter chip according to claim 1, wherein said MMIC chips comprise a sub-harmonic mixer MMIC chip that receives and mixes together an Intermediate Frequency (IF) signal and Local Oscillator (LO) signal and up converts the IF signal into a higher frequency RF signal.

3. A Block Up Converter chip according to claim 2, wherein said MMIC chips comprise a driver amplifier MMIC and a high power amplifier (HPA) MMIC operatively connected to the sub-harmonic mixer MMIC chip for amplifying the RF signal.

4. A Block Up Converter chip according to claim 1, wherein said top cover comprises an inside surface over the MMIC chips and having channelization providing isolation between RF circuits and MMIC chips.

5. A Block Up Converter chip according to claim 4, and further comprising a metallized layer on the inside surface of the top cover and forming a waveguide channel.

6. A Block Up Converter chip according to claim 1, and further comprising vias extending through the base board for connecting the top and bottom RF grounds.

7. A Block Up Converter chip according to claim 1, and further comprising vias extending from the top metal layer to bottom signal pads for carrying input and output signals.

8. A Block Up Converter chip according to claim 1, wherein said bottom metal layer is configured for surface mounting on an RF board.

9. A Block Up Converter chip according to claim 1, and further comprising flanges formed for mounting the base board, said flanges including signal terminals operative with the MMIC chips and RF circuits.

10. A Block Up Converter chip according to claim 1, and further comprising surface mounted by-pass capacitors on the base board, and wire bonds interconnecting by-pass capacitors and MMIC chips to RF circuits.

11. A Block Up Converter chip according to claim 1, and further comprising cut-outs formed within the base board which receive respective MMIC chips, and conductive epoxy securing said MMIC chips within said cut-outs to said bottom metal layer.

12. A Block Up Converter chip comprising:
a base board formed from a dielectric material and opposing top and bottom metal layers forming respectively a top ground and bottom RF ground, said top metal layer having Radio Frequency (RF) circuits and said bottom metal layer having ground and signal pads, said base board having cut-outs;
a microwave monolithic integrated circuit (MMIC) chip received in each cut-out, said MMIC chips comprising a sub-harmonic mixer MMIC that receives and mixes together an Intermediate Frequency (IF) signal and Local Oscillator (LO) signal and up converts the IF signal into a higher frequency RF signal, a driver amplifier MMIC, and a high power amplifier (HPA) MMIC operatively connected to the sub-harmonic mixer MMIC for amplifying the RF signal;
a surface mounted IF amplifier operatively connected to said sub-harmonic mixer MMIC for amplifying the IF signal into the sub-harmonic mixer MMIC;
filters formed on the base board and operative with the HPA MMIC, driver amplifier MMIC and sub-harmonic mixer MMIC; and
a top cover positioned over said base board for protecting said MMIC chips.

13. A Block Up Converter chip according to claim 12, wherein said top cover comprises an inside surface over the MMIC chips and having channelization providing isolation between RF circuits and MMIC chips.

14. A Block Up Converter chip according to claim 13, and further comprising a metallized layer on the inside surface of the top cover and forming a waveguide channel.

15. A Block Up Converter chip according to claim 12, and further comprising vias extending through the base board for connecting the top ground and bottom RF ground.

16. A Block Up Converter chip according to claim 12, and further comprising vias extending from the top metal layer to bottom signal pads for carrying input and output signals.

17. A Block Up Converter chip according to claim 12, wherein said bottom metal layer is configured for surface mounting on an RF board.

18. A Block Up Converter chip according to claim 12, and further comprising flanges formed for mounting the base board, said flanges including signal terminals operative with the MMIC chips and RF circuits.

19. A Block Up Converter chip according to claim 12, and further comprising surface mounted by-pass capacitors and wire bonds interconnecting by-pass capacitors and MMIC chips to RF circuits.

20. A Block Up Converter chip according to claim 12, and further comprising conductive epoxy securing said MMIC chips within said cut-outs to said bottom metal layer.

21. A method of forming a Block Up Converter chip, which comprises:
forming Radio Frequency (RF) circuits on a top metal layer of a base board;
forming ground and signal pads on a bottom metal layer;
inserting MMIC chips within cut-outs formed within the base board;
interconnecting the MMIC chips and RF circuits such that received signals can be up converted; and
positioning a top cover over the base board for protecting the MMIC chips.

22. A method according to claim 21, which further comprises forming vias that extend through the base board for connecting the top metal layer as a top ground and bottom metal layer as an RF ground.

23. A method according to claim 21, which further comprises forming vias that interconnect signal pads and RF circuits.

24. A method according to claim 21, wherein the MMIC chips comprise a sub-harmonic mixer MMIC chip that receives and mixes together an Intermediate Frequency (IF) signal and Local Oscillator (LO) signal and up converts the IF signal into a higher frequency RF signal, a driver amplifier MMIC, and a high power amplifier (HPA) MMIC operatively connected to the sub-harmonic mixer MMIC for amplifying the RF signal.

25. A method according to claim 24, which further comprises surface mounting an IF amplifier on the base board and operatively connecting the IF amplifier to the sub-harmonic mixer MMIC for amplifying the IF signal into the sub-harmonic mixer MMIC.

26. A method according to claim 21, which further comprises etching filters on the top metal surface of the base board.
